(19) United States
(12) Patent Application Publication
(10) Pub. No.: US 2015/0213687 A1
(43) Pub. Date: Jul. 30, 2015

(54) System and Method for a Card Game

(71) Applicant: Boris Shoihat, Or Akiva (IL)

(72) Inventor: Boris Shoihat, Or Akiva (IL)

(21) Appl. No.: 14/166,587

(22) Filed: Jan. 28, 2014

(51) Int. Cl. G07F 17/32

(52) U.S. Cl. CPC G07F 17/3293; G07F 17/3276; G07F 17/3244

(57) ABSTRACT

A method for playing a poker game on a network is provided. The method includes receiving a first request from at least one of a plurality of clients for the poker game, providing a virtual table having a plurality of available spaces for at least another of the plurality of clients, receiving at least a second request from at least a second of the plurality of clients for the poker game, beginning the game play so that all player are required to make a blinds bets.

### FIELD OF THE INVENTION

The present invention relates generally to a card game. More particularly, the invention relates to a networked and web-based computer platform for poker games.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

Poker, and in particular a style of poker called “Texas hold'em” or “No limit hold′em’, has seen an unprecedented surge of popularity over the last 15 years. Much of the surge can be attributed to the advent of online poker, which allows players of all skill levels to compete from the comfort of their own home, against like-minded players with similar skill levels, or against professional players if they so chose.

It is estimated that over 40 million people play poker regularly: 15 million in total play online for real money (7 million play online for real money at least once a month, 5 million play for real money at least once a month in “Home Games”, 2 million play for real money at least once a month in “Private Clubs” and 10 million play in a casino each year. Games include Texas hold'em, Omaha, Omaha Hi/Lo (8 or Better), Stud, Stud Hi/Lo (8 or Better), Razz, Five-card draw, 2-7 Triple Draw & 2-7 Single Draw, Badugi, HORSE, HOSE, Mixed Hold'em, Mixed Omaha Hi/Lo, Triple Stud and 8-Game Mix. However, Texas hold'em has seen the largest increase in players, due in part to its television-friendly rules.

Online poker, in particular, has seen a substantial rise in popularity over the last decade, in both websites that allow the use of real money, and also those that use play money. At any one time, a player has the ability to choose from hundreds of different websites each of which may have anywhere from a few hundred players at multiple tables, to thousands of players at multiple tables. Invariably, the players skill ranges from first time players, who may play only a couple of raked hands, to professionals, who play hundreds of raked hands per day. This leads to online pokers largest “problem”: Fairness and competitive advantage.

While some websites attempt to group players according to their respective skill level, it is many times a subjective decision, most often left to the player themselves. As such, there is little to stop a professional from joining an amateur table to gain competitive advantage. Amongst professionals, it is known that there is little competitive advantage when playing against other professionals in online poker, when compared to live table poker since you cannot discern body movements and “read” the other players. Thus, the easiest way to gain this advantage is to join games in which the players are amateur. Many professionals can read players, even online, based simply on that the fact that less-experienced players ponder their decisions and give their hands away by the amount of time it takes to act on their hands—if they have a marginal hand, the professional can tell, and play accordingly.

Another important differentiator between amateur and professional players occurs pre-flop. Casual poker players typically like to see flops. The pre-flop fold is often perceived as the discipline that differentiates winning and losing players—professionals and amateurs. Folding one's cards during the action that occurs before the flop means that the player will not take part in the hand that is about to be dealt. For a professional, a meaningful and potentially profitable part of the game, especially for an online professional that plays over ten tables at once.

For an amateur playing a single table, it means not playing until other players are done playing the hand, while the player is nothing but an observer. Folding a hand and later seeing how it could have connected when community cards were dealt is one of the key reasons why amateur tend to see more flops; the emotional connection and curiosity to see “what may have been”, whereas the professionals tend avoid this emotional connection.

Referring now to FIG. 1, a flow-chart of a Texas hold'em game is shown generally at 100. This flow chart is shown for exemplary purposes only, and represents a traditional-style game of hold'em, played either online or live. At step 102, individual cards are dealt.

At step 104, blind bets are placed. As used herein, “blinds” refer to a forced bet placed into the pot by one or more players before the deal begins, in a way that simulates bets made during play.

As step 106, a round of action occurs in which players have the option to bet or fold.

At step 108, players not willing to call the blind bets or call another player's raises to discard their cards.

At step 110, the first three of five community cards are dealt. As used herein, this is referred to as the “flop”.

At step 112, another round of action occurs among the players who have called or raised the pre-flop bets. In this round, players can check, call, bet or raise the action.

At step 114, players not willing to call the bets made by other players discard their cards. These players are still able to view the rest of the game.

At step 116, the fourth community card is revealed. As used herein, this is referred to as the “turn”, or “fourth street”.

At step 118, another round of action occurs among the players who have called the flop bets. In this round, players can check, call, bet or raise the action.

At step 120, players not willing to call the bets made by other players discard their cards. These players may also view the remainder of the game.

At step 122, the fifth, and last community card is dealt. As used herein, this is referred to as the “river”

At step 124, another round of action occurs among the players who have called the turn bets. In this round, players can check, call, bet or raise the action.

As step 126, players not willing to call the bets made by other players discard their cards. They may also continue to view the game.

At step 128, in case last bet is called, the hands are revealed and the winner is decided based on hand strength.

In Texas hold'em games that follow this pattern, professional players have a large competitive advantage over amateur players, in part due to the reasons described above. While some websites attempt to classify players by skill to obviate these fairness issues, it is difficult to monitor. Also, amateur players have more “down-time” than professionals, because they will spend time watching a game after folding pre-flop, rather than playing in a different game. This equates to lost revenue for the games provider.

Accordingly, there is a need for a system and method to better regulate the fairness of poker games, while also obviating amateur “down-time” and contributing the overall experience for all player, whether during online games or live games.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart depicting a prior art embodiment of a Texas hold'em poker game;

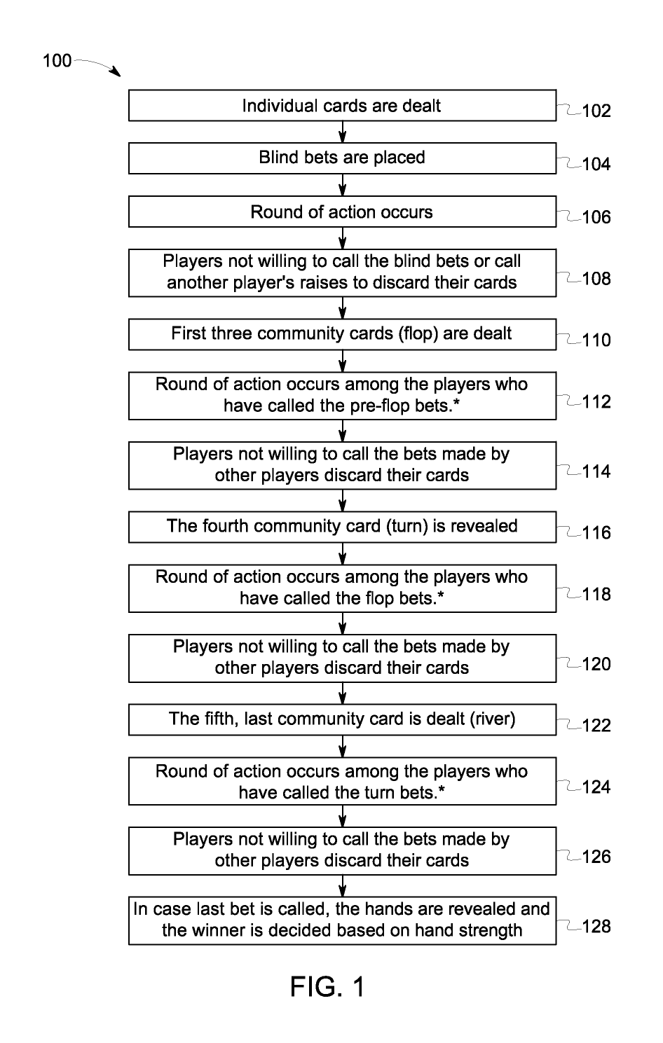

FIG. 2 is a block diagram showing an exemplary construct for use with the present invention;

FIG. 3 is a detailed block diagram depicting an exemplary client/server system which may be used by an exemplary web-enabled/networked embodiment of the present invention;

FIG. 4 illustrates a flowchart depicting a method for a poker game in accordance with an embodiment of the present invention.

FIG. 5 illustrates a user-choice flowchart depicting a method for, in accordance with an embodiment of the present invention.

Unless otherwise indicated illustrations in the figures are not necessarily drawn to scale.

### SUMMARY OF THE INVENTION

To achieve the forgoing and other aspects and in accordance with the purpose of the invention, a system, method and computer program product for implementing a poker game is described.

In an embodiment of the present invention, a method for playing a poker game on a network, the method executed by one or more computing processors, is provided. The method comprises playing a poker game on a network, the method executed by one or more computing processors, the method comprising receiving a first request from at least one of a plurality of clients for the poker game, providing a virtual table having a plurality of available spaces for at least another of the plurality of clients, receiving at least a second request from at least a second of the plurality of clients for the poker game, beginning the game play, the game play comprising requiring a blinds bet of all of the plurality of clients.

In an embodiment of the present invention, a processor-based system for playing a poker game on a network is provided, the system comprising at least one server comprising a memory, a network interface for communicating with a plurality of gaming devices, a processor coupled to the memory and the network interface, said processor, memory, and interface configured to receive a first request from at least one of a plurality of clients for the poker game, provide a virtual table having a plurality of available spaces for at least another of the plurality of clients, receive at least a second request from at least a second of the plurality of clients for the poker game, beginning the game play by requiring a blinds bet of all of the plurality of clients.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain types of online poker games, a skilled artisan will realize that embodiments of the invention are applicable to live games as well, such as a physical poker game environment as in a casino. The software game application may be hosted on a server, which is in communication with application by clients over closed or open networks.

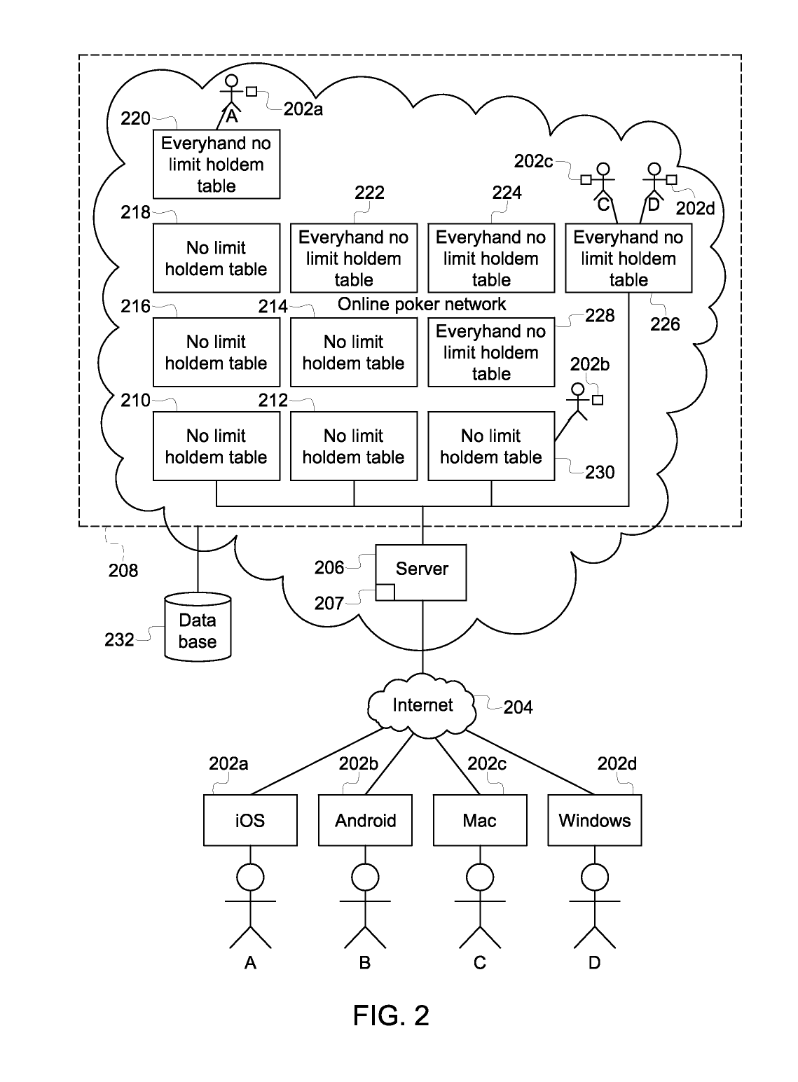

Referring now to FIG. 2, a block diagram depicting an exemplary client/server system which may be used together with an exemplary embodiment of the present invention is shown generally at 100.

Clients 202a, 202b, 202c and 202d represent user devices at which one or more independent users (also referred to herein as “players”) may participate in a poker game. The clients 202a-d, in this exemplary embodiment, are smart phones. However, it should be appreciated that clients 202a-d may also include personal digital assistants, tablet devices, e-readers, wireless music devices and any other personal computing device such as desktops and laptops, which includes at least one of a display, processor, memory or input or output means, together with any electronic device that is used as a platform for audio-visual media including games and mobile applications. Further, it should be noted that while only four clients 202a-d are shown, the present methods and systems are applicable to large volume networks in the order of hundreds of thousands or millions of clients.

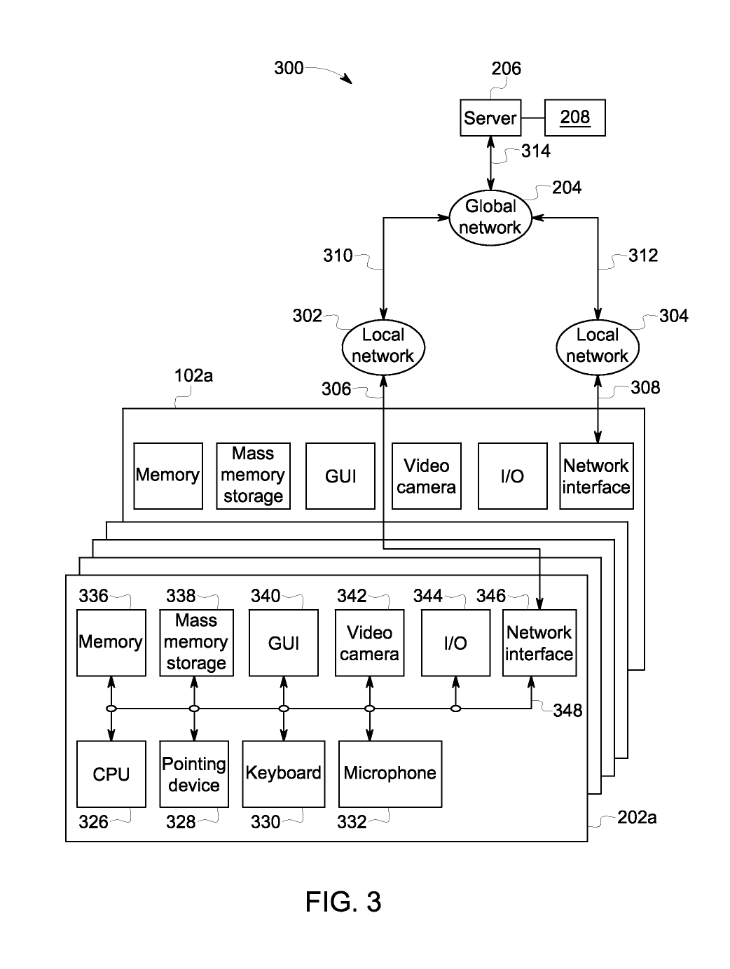

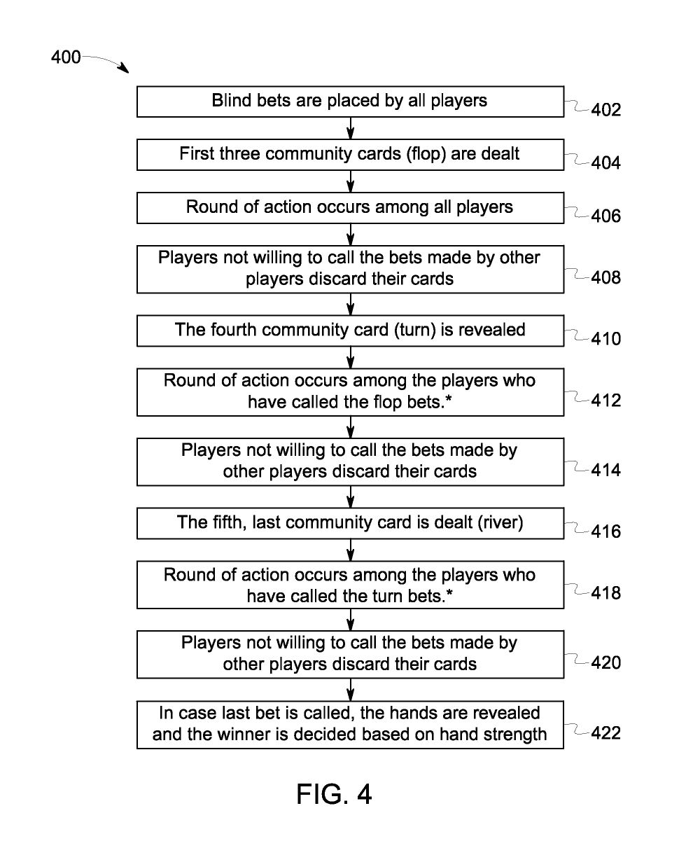

The clients 202a-d, in an embodiment of the present invention, may be communicatively connected to each other, and further communicably connected to at least a server 206 via network 204. The server 206 may be in further communication with a computing processor 207, which will be discussed in further detail with relation to FIGS. 3 and 4.

A server-side poker network is shown generally at 208. As shown, the network comprises a plurality of poker tables 210, 212, 214, 216, 218, 220, 220, 222, 224, 226, 228 and 230. The number of tables is scalable by any number. In this exemplary embodiment, the player using clients 202a is logged in at table 220, the player that is using client 202b is logged in at table 230, and player using client 202c is at table 226, and the player using client 202d is also at table 226. While games shown are every hand no limit hold'em, and no limit hold'em, other games such as fixed limit hold'em, spread limit hold'em, pot limit hold'em, and mixed game hold'em.

In operation, a player can enter the poker room/table through the use of a user interface screen which may be used by an exemplary web-enabled embodiment of the present invention for creating a new table of for joining a table. The user interface screen may be further configured to allow a user to join or create a table. The database 232 has, in its memory, the games shown at server side network 208. The database and 232 and server-side processor may combine to initialized the games.

Referring now to FIG. 3, a more detailed block diagram depicting an exemplary client/server system which may be used together with an exemplary embodiment of the present invention, which is shown generally at 300.

In this exemplary embodiment, the system 300 includes clients with a sampling of clients denoted as a client 102a, together with local networks 302 and 304, the global network 306 and servers 206.

In this exemplary embodiment of the present invention, client 102a may communicate bi-directionally connected with local network 302 via a communication channel 308. Client 102a may communicate bi-directionally with local networks 304 via a communication channel 306. Local network 302 may communicate bi-directionally with global network 304 via a communication channel 310. Local network 304 may communicate bi-directionally with global network 204 via a communication channel 312. While only two distinct local networks are shown, exponentially more networks may be in communication with the servers at any one time.

Global network 204 may communicate bi-directionally with server 206 via a communication channel 314. Furthermore, clients 102a-c, local networks 302, 304, global network 204 and server 306 may each communicate bi-directionally with each other over global network 204. There are also generally one or more gateways (not shown) connecting the local networks 202, 204 and the servers 106, 206 to the global network 104.

The global network 204 may comprise the Internet, local area networks (LANs), wide area networks (WANs), wired telephone networks, wireless networks, or any other network supporting data communication between respective clients, developers, servers, and the like.

Client 102a, which in this exemplary embodiment are smart phones, may comprise various known hardware, software, and firmware. For example, the smart phones may comprise a CPU 326, a sensory representation (a visual, auditory, or tactile output such as a graphic display, a tone, or a vibration) 328, a keyboard/touchpad 330, a microphone 332, a memory 336, a mass memory storage 338, a graphical user interface 340, a video camera 342, an input/output interface 344 and a network interface 346. The client may also include removable media devices (e.g., memory cards, etc).

CPU 326 may be comprised of a single processor or multiple processors. CPU 326 may be of various types including micro-controllers (e.g., with embedded RAM/ROM) and microprocessors such as programmable devices (e.g., RISC or CISC based, or CPLDs and FPGAs) and devices not capable of being programmed such as gate array ASICs (Application Specific Integrated Circuits) or general purpose microprocessors.

Memory 336 is used to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 138 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 126 might receive information from the network, or might output information to a network in the course of performing the method steps described in the teachings of the present invention. Smartphones may communicate via remote connectivity including, but not limited to the Internet, Satellite networks, Cell Phone networks, other wireless networks and standards such as 802.11, 80211 .b, 802.11 g, or similar wireless LAN operating standards, or Bluetooth technologies, infrared connections, or any other similar technologies or other technologies such as those described above that permit the sending and/or receiving and/or processing of electronic information in either an encrypted or unencrypted format.

In exemplary embodiments of the present invention, the client 102a has the ability connect to application stores (e.g., Apple App Store, Android Market, MiKandi, Amazon App Store and BlackBerry App World), and the poker game is fully downloadable and integratable into any type of client.

In an embodiment of the present invention, the server 206, through a plurality of processors, software, and firmware, is configured to execute a poker game according to the method shown in the flow-chart of the FIG. 4. This poker game pattern better regulates the fairness of the poker game, lessens the competitive advantage that professional players have over their amateur counterparts, and also keeps amateur players playing more raked hands in a given time frame, thus increasing revenue for the games host. While this exemplary embodiment is related to an online, networked game of no limit Texas hold'em, other types of Texas hold'em are in the purview of the invention.

Referring now to FIG. 4, there is shown a flow chart to further illustrate a method for increasing user value in an online gaming environment at 400, where the house is a server. The method, executable by the system, will be described with reference to FIG. 2, and clients 102a-d, wherein clients 102a and 102b are professional players, and 102c and 102d are amateur players. Each of the clients 102a-d join the table using known methods of joining poker table over a networked platform.

In optional embodiments, the house (e.g., the entity hosting the game) may be a casino, hotel or hosting service. The dealer may be the players themselves as well, rotating after each raked hand.

At step 402, blinds are placed by all players 102a, 102b, 102c and 102d. In this exemplary embodiment, the blinds are the same monetary amount (real or play money). Each of the clients 102a-102d are forced to place the same blinds bet, thus not allowing any player to fold his or her hand without placing a bet. The inducers a regular cost to take part in all games, thus inducing a player to enter pots in an attempt to compensate for that expense. Also, this particular may rule lessen the competitive advantage that the professionals 102a and 102b possess by understanding the best and most lucrative time to fold, or not to fold, pre-flop. None of the players may fold prior to betting the amount of the blinds, but may choose to fold later in the game.

At step 404, the flop occurs, in which three community cards are dealt.

At step 406, a round of action occurs for all players, clients 102a-d. The round of action signifies the first opportunity to either check, bet, call, raise of fold. In this exemplary embodiment, professional player at client 102a bets.

At step 408, players at clients 102b-102d not willing to call the bet made by player at client 102a are allowed to fold their cards. In this exemplary embodiment, all players call. In a networked environment, the player who folded has the option to stay and watch the rest of the game, or move directly to another game.

At step 410, the turn card is revealed.

At step 412, another round of action occurs for all players, clients 102a-d. The round of action signifies the next opportunity to either check, bet, call, raise of fold.

At step 414, players not willing to call bets made by other players discard their cards. In this exemplary embodiment, professional player at client 102a bets, professional player 102b folds, amateur 102c raises, and 102d calls the raise. Professional 102a re-raises, and both amateurs 102c and 102d call.

At step 416, the river card is dealt. This signifies the final community card dealt.

At step 418, another round of actions occurs amount players who have called the turn bets. The round of action signifies the next opportunity to either check, bet, call, raise of fold.

At step 420, players not willing to call the bets made by other players fold. In this exemplary embodiment, professional player at client 102a bets, while amateur 102c raises and 102d folds.

At step 422, the last bet is called, the hands are revealed and the winner is decided based on hand strength.

As can be seen in this exemplary embodiment, in this particular pattern of Texas hold'em, the amateur player has will likely find the game more interesting, and thus, will likely play more raked hands. Also, since betting is involved by all players in every game, the platform will see greater revenue based on target user time, whether it be through direct customer revenue or advertiser revenue.

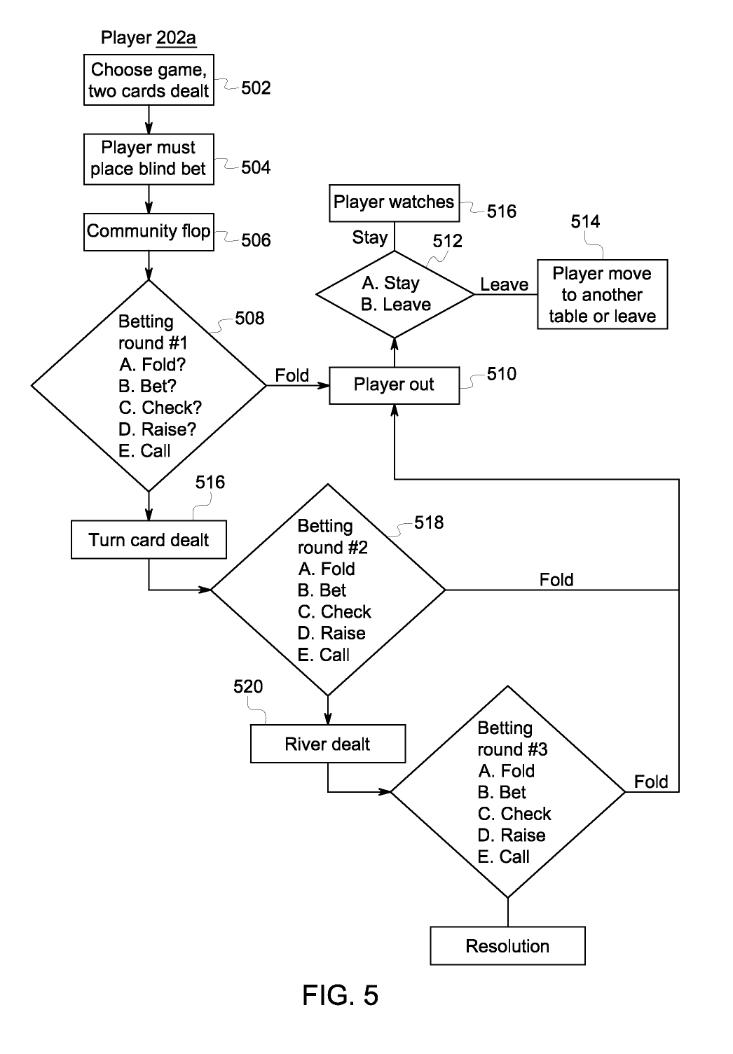

Referring now to FIG. 5, a flow chart showing the game play for a single player (player 202a). In this exemplary embodiment, a single game is shown along with options a player possesses in each betting round. The only time a player has the ability to bet is when the player is the first person to contribute to the pot on that round; if someone has bet before them in that round, they can only call, raise or fold.

The player 202a may also call at a betting round. The only prerequisite that comes with calling is that you must match the amount of any previous bets or raises in that round.

The player 202a also has the opportunity in a betting round to raise if another player has already opened the pot on that round of betting. If the pot has already been raised on that betting round, re-raising is also an option.

The player 202a may fold in any betting, but does not have the option of doing so pre-flop.

Lastly, the player 202a may check if the pot hasn't been opened yet. If someone has bet the player 202a may not longer check, and can only call, raise or fold.

In the step-wise diagram at 502, the player 202a choose the game, sits down either virtually over a network, or physically at a table at the house. Once the game begins, the player is dealt two cards, only viewable by the player. These are the only two non-community cards.

In step 504, the player must place a blinds bet, no matter what the blinds are. There may be a single blind for the entire table, or there may be large blinds and small blinds for a selected group of players, however, all players must place a blinds bet, small or large.

At step 506, the community flop is dealt, in which three cards are dealt on the table face up.

At step 508, the player 202a then has a decision tree, since it is the first round of betting. The player who is to the left of the dealer, or acting as the dealer has the first betting option. This first besting option will rotate around the table at each betting round, going in a predetermined direction around the table. At this first betting round #1, the player may fold, check, raise or call. If the player is the first in queue, the player may bet according to the rules.

If the player folds, the player is out, step 510. If the player is out, the player has the option to stay or leave at step 512. The player may leave and join a new game 514, or watch 516.

At step 516 the turn card is dealt to the community cards. The player 292a is now at the second decision tree, betting round #2, step 518. The player who is to the left of the player that bet on betting round #1 has betting option. At this second betting round #2, the player may fold, check, raise or call. If the player is the second in queue, the player may bet according to the rules.

If the player folds, the player is out, step 520. If the player is out, the player has the option to stay or leave at step 512. The player may leave and join a new game 514, or watch 516.

Next, the river card is dealt, and the player 292a is now at the second decision tree, betting round #3, step 522. The player who is to the left of the player that bet on betting round #2 has betting option. At this third betting round #3, the player may fold, check, raise or call. If the player is the second in queue, the player may bet according to the rules.

Lastly, after all betting is complete, a resolution occurs in which the strongest hand is the winner.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A method for playing a poker game on a network, the method executed by one or more computing processors, the method comprising:
receiving a first request from at least one of a plurality of clients for the poker game;
providing a virtual table having a plurality of available spaces for at least another of the plurality of clients;
receiving at least a second request from at least a second of the plurality of clients for the poker game;
beginning the game play, the game play comprising:
requiring a blinds bet of each of the plurality of clients.

2. The method of claim 1, wherein the blinds are a same monetary amount, and wherein the monetary amount is real money or play money.

3. The method of claim 1, wherein the game play further comprises flopping three community cards.

4. The method of claim 1, wherein the game play further comprises indicating, to the clients, for a first round of action, when action comprises the clients having a first opportunity to check, bet, call, raise or fold.

5. The method of claim 1, wherein the game play further comprises dealing a turn card as a fourth community card.

6. The method of claim 1, wherein the game play further comprises indicating, to the clients, for a second round of action, wherein the second round of action comprises the clients having a second opportunity to check, bet, call, raise or fold.

7. The method of claim 1, wherein the game play further comprises dealing a river card as the fifth community card.

8. The method of claim 1, wherein the game play further comprises indicating, to the clients, for a third round of action, wherein the action comprises the clients having a third opportunity to check, bet, call, raise or fold.

9. The method of claim 8, wherein the clients, upon folding, are immediately denied access to view the poker game.

10. The method of claim 8, wherein the clients are permitted access to view the poker game after a fold.

11. A system for playing a poker game on a network, the system comprising:
at least one server comprising:
a memory;
a network interface for communicating with a plurality of gaming devices;
a processor coupled to the memory and the network interface, said processor, memory, and interface configured to:
receive a first request from at least one of a plurality of clients for the poker game;
provide a virtual table having a plurality of available spaces for at least another of the plurality of clients;
receive at least a second request from at least a second of the plurality of clients for the poker game;
beginning the game play by requiring a blinds bet of all of the plurality of clients.

12. The method of claim 1, wherein the blinds are a same monetary amount, and wherein the monetary amount is real money or play money.

13. The system of claim 11, wherein the game play further comprises flopping three community cards.

14. The system of claim 11, wherein the game play further comprises indicating, to the clients, for a first round of action, wherein the action comprises the clients having a first opportunity to check, bet, call, raise or fold.

15. The system of claim 11, wherein the game play further comprises dealing a turn card as a fourth community card.

16. The system of claim 1, wherein the game play further comprises indicating, to the clients, for a second round of action, wherein the second round of action comprises the clients having a second opportunity to check, bet, call, raise or fold.

17. The system of claim 11, wherein the game play further comprises dealing a river card as the fifth community card.

18. The system of claim 11, wherein the game play further comprises indicating, to the clients, for a third round of action, wherein the action comprises the clients having a third opportunity to check, bet, call, raise or fold.

19. The system of claim 18, wherein the clients, upon folding, are immediately denied access to view the poker game.

20. The system of claim 18, wherein the clients, upon folding, are permitted access to view the poker game.
